(19) United States
(12) Patent Application Publication
(10) Pub. No.: US 2026/0178038 A1
(43) Pub. Date: Jun. 25, 2026

(54) DYNAMIC NAVIGATION SYSTEM AND METHOD

(71) Applicant: Swift Beat, LLC, Menlo Park, CA (US)

(72) Inventors: David BOTTON, Fort Lauderdale, FL (US); Alexander MEZHIROV, Lexington, MA (US)

(21) Appl. No.: 19/460,260

(22) Filed: Jan. 26, 2026

Related U.S. Application Data
(63) Continuation-in-part of application No. 19/426,040, filed on Dec. 18, 2025.
(63) Continuation-in-part of application No. 19/452,194, filed on Jan. 16, 2026.
(60) Provisional application No. 63/737,568, filed on Dec. 20, 2024.
(60) Provisional application No. 63/746,895, filed on Jan. 17, 2025.
(60) Provisional application No. 63/750,068, filed on Jan. 27, 2025.
(60) Provisional application No. 63/893,387, filed on Oct. 3, 2025.

(51) Int. Cl. G05D 1/46; G05D 1/617; G05D 1/683; G05D 105/35; G05D 109/25

(52) U.S. Cl. CPC G05D 1/46; G05D 1/617; G05D 1/683; G05D 2105/35; G05D 2109/254

(57) ABSTRACT

A system includes a processor configured to: change operation of a mobile platform to a first deployed mode of the mobile platform; navigate the mobile platform along a flight path toward at least one of a target or a source utilizing the first deployed mode, change operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjust a logarithmic flight path of the mobile platform based on a real-time input utilizing the second deployed mode; and execute the adjusted logarithmic flight path with the mobile platform utilizing the second deployed mode.

### CROSS-REFERENCE TO RELATED APPLICATIONS

This non-provisional utility application claims priority to provisional patent application No. 63/750,068, entitled “DYNAMIC NAVIGATION SYSTEM AND METHOD” and filed on Jan. 27, 2025, provisional patent application No. 63/893,387, entitled “RADIO FREQUENCY DETECTION” and filed on Oct. 3, 2025, is a continuation-in-part and claims priority to non-provisional patent application Ser. No. 19/426,040, entitled “EMITTER SELECTION” and filed on Dec. 18, 2025, which claims priority to provisional application No. 63/737,568, entitled “EMITTER SELECTION,” and filed on Dec. 20, 2024, and is a continuation-in-part and claims priority to non-provisional patent application Ser. No. 19/452,194, entitled “RADIO FREQUENCY LANDSCAPE MAP” and filed on Jan. 16, 2026, which claims priority to provisional application No. 63/746,895, entitled “RADIO FREQUENCY LANDSCAPE MAP,” and filed on Jan. 17, 2025, each of which is incorporated herein in its entirety by reference.

### BACKGROUND

Existing approaches for autonomous navigation lack flexibility and suffer from numerous shortcomings.

### SUMMARY

In one aspect, a system includes a processor and a memory including computer program code, wherein the memory and the computer program code are configured to, with the processor, cause the processor to: change operation of a mobile platform to a first deployed mode of the mobile platform; navigate the mobile platform along a flight path toward at least one of a target or a source utilizing the first deployed mode, change operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjust a logarithmic flight path of the mobile platform based on a real-time input utilizing the second deployed mode; and execute the adjusted logarithmic flight path with the mobile platform utilizing the second deployed mode.

In another aspect, a computerized method includes: changing operation of a mobile platform to a first deployed mode of the mobile platform; navigating the mobile platform along a flight path toward at least one of a target or a source utilizing the first deployed mode; changing operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjusting a logarithmic flight path of the mobile platform based on a real-time input utilizing the second deployed mode; and executing the adjusted logarithmic flight path with the mobile platform utilizing the second deployed mode.

In another aspect, a system includes: a processor; and a memory comprising computer program code, the memory and the computer program code configured to, with the processor, cause the processor to: navigate a mobile platform along a path toward at least one of a target or a source; and perform a maneuver with the mobile platform based on at least one of a sensor input, a real-time input, an environmental change, a distance to the at least one of the target or the source, movement of the at least one of the target or the source, or a change to the at least one of the source or target, wherein performing the maneuver comprises selecting a maneuver pattern based on at least one of a threat profile, an operational state of the mobile platform, an environmental condition, or a repository of maneuver patterns.

### BRIEF DESCRIPTION OF THE DRAWINGS

FIG. 1 is a schematic diagram illustrating a navigation system according to an implementation.

FIG. 2 is a table illustrating an example of a states and modes framework of the system shown in FIG. 1 according to an implementation.

FIG. 3 is a table illustrating an example of the states and modes framework of the system shown in FIG. 1 according to an implementation.

FIG. 4 is a table illustrating an example of operational parameters of the system shown in FIG. 1 according to an implementation.

FIG. 5 is a flowchart illustrating the states and modes framework of the system shown in FIG. 1 according to an implementation.

FIG. 6 is a schematic diagram illustrating an exemplary software implementation of the system shown in FIG. 1 according to an implementation.

FIG. 7 is a graph illustrating an example comparison between two distinct approach trajectories according to an implementation.

FIG. 8 is a graph illustrating an example of a log approach of the system shown in FIG. 1 according to an implementation.

FIG. 9 is a graph further illustrating the log approach according to an implementation.

FIG. 10 is a graph further illustrating the log approach according to an implementation.

FIG. 11 is a graph further illustrating the log approach according to an implementation.

FIG. 12 is a flowchart illustrating a method of operation of the navigation system of FIG. 1 according to an implementation.

FIG. 13 is a flowchart illustrating a method of operation of the navigation system of FIG. 1 according to an implementation.

FIG. 14 is a flowchart illustrating a method of operation of the navigation system of FIG. 1 according to an implementation.

FIG. 15 is a schematic diagram illustrating the navigation system of FIG. 1 being deployed onboard a mobile platform according to an implementation.

FIG. 16 is a schematic diagram illustrating an exemplary operating environment of the disclosure according to an implementation.

### DETAILED DESCRIPTION

Existing approaches for autonomous navigation lack flexibility at least because they rely on pre-planned navigation routes and/or static engagement strategies. For example, existing navigation systems cannot adapt to unforeseen changes during operation. In one example, existing terminal engagement strategies utilize predefined flight paths, which may result in inaccurate navigation to the target. In another example, existing trajectory correction techniques lack responsiveness in dynamic environments.

Another example of the shortcomings of existing navigation systems includes navigation methodologies that rely on global positioning system (GPS) based guidance and/or waypoint navigation, which for example is less adaptable to environmental and/or other changes.

Energy management is also a shortcoming of existing navigation systems. For example, some known systems focus on battery conservation, which may provide insufficient available energy at some point and thereby constrain the operational efficiency of the system (e.g., during extended operations) and/or restrict operation duration.

In contrast, aspects of the disclosure provide systems and methods for navigation within dynamic environments. A states and modes framework enables dynamic adaptability by governing transitions across distinct operational phases such as, but not limited to, pre-motion, transit, search, search and detect, track, track and target, engagement, terminal, and/or the like.

Aspects of the disclosure are operable in a range of applications including, but not limited to: aerial surveying, reconnaissance, and/or mapping; emergency response; disaster response and/or management; agricultural applications; telecommunications; environmental and/or conservation applications; infrastructure; and/or the like.

In an example implementation for aerial surveying, reconnaissance, and/or mapping, a system equipped with the states and modes framework disclosed herein is used in surveying and/or mapping operations where adaptability to diverse terrains is helpful and/or required. For example, during a search and detect mode as disclosed herein, a navigation system enables one or more sensors to gather geographical data, intelligence data, real-time data, terrain-related information, and/or the like. In another example, a track and target mode is configured to perform close surveillance, follow specific terrain features for more comprehensive mapping, and/or the like. Aspects of the disclosure may be particularly useful for urban planning, ecological studies, and/or infrastructure development to collect relatively precise topographical data.

Disaster response and/or management is another example implementation of the disclosure. For example, in disaster response scenarios, the log approach strategy disclosed herein is used to assess structural integrity, pinpoint areas needing urgent attention, and/or the like. In another example, the navigation and/or real-time data acquisition capabilities described herein facilitate the identification of safe paths for evacuation, delivery of supplies, and/or the like. In such examples, the intelligent breadcrumb navigation methods disclosed herein avoid zones considered hazardous to a mobile platform using the navigation system. The systems and methods disclosed herein are operable in search and rescue operations, for example using optical, acoustic, thermal, and/or other sensors and/or signals to locate survivors, locate personnel, detect signals from distress beacons, assess fire hotspots, and/or the like.

In another example, aspects of the disclosure are implemented in agricultural monitoring and/or management applications. For example, the integrated sensing capabilities disclosed herein (e.g., including radio frequency (RF) direction finding and/or short-range radar) are adaptable for agricultural monitoring to provide precise data on crop health and/or growth patterns. The adaptive operational modes (e.g., the states and modes framework) disclosed herein enable relatively early detection of crop disease and/or pest infestations and targeted interventions to optimize crop yield, resource use, etc. The integration of solar energy, fuel cartridges, combustible fuels, and/or the like, as disclosed herein, provides extended operational periods which is particularly beneficial for large-scale agricultural areas.

Environmental monitoring and/or conservation is another example implementation of the disclosure. For example, the navigation system disclosed herein is used to monitor environmental characteristics such as, but not limited to, wildlife movements, water levels, and vegetation health. Moreover, and for example, the trajectory corrections disclosed herein (e.g., the logarithmic flight correction, etc.) enhance the precision of data collection in areas with fluctuating environmental conditions. In another example, the evasive maneuvers disclosed herein support the safe navigation of mobile platforms in relatively sensitive ecosystems to minimize disruption while conducting research and/or conservation efforts.

Infrastructure inspection and/or maintenance examples of the disclosure include the inspection of infrastructure such as, but not limited to, bridges, power lines, pipelines, and/or the like. For example, the systems and methods disclosed herein can be used to detect structural anomalies and/or energy leaks, which can inform maintenance decisions and operations.

Another exemplary implementation of the systems and methods disclosed herein includes telecommunications and/or network support. For example, the systems disclosed herein deploy in network maintenance and/or development operations using sensing and/or navigational capabilities to assess network signal strength and/or establish temporary communication links in remote areas.

In a logistics example, aspects of the disclosure are deployed for autonomous supply operations in difficult and/or contested environments. The energy management systems disclosed herein extend the operational range of mobile platforms to deliver supplies to distant and/or remote locations.

Aspects of the disclosure provide a log approach strategy that dynamically adjusts approach trajectory, for example to optimize accuracy via continuous trajectory correction based on real-time inputs. For example, aspects of the disclosure dynamically adjust a logarithmic flight path of a mobile platform using a pseudo-Kalman filtering technique, thereby improving accuracy of navigation to a target. Aspects of the disclosure provide (e.g., evasive, etc.) maneuver strategies that incorporate input from multiple sensors, such as, but not limited to, microphones, optical sensors, thermal sensors, and/or the like, to adjust navigation and/or direction of the mobile platform.

In some examples, aspects of the disclosure provide intelligent breadcrumb navigation that facilitates path creation based on real-time data for improved navigation and/or avoiding particular areas (e.g., hazardous zones). Aspects of the disclosure provide a redundant flight management system that utilizes encryption and/or volatile memory to heighten data security. Aspects of the disclosure include battery management protocols, including integrating solar energy, combustible fuels, and/or expendable battery cartridges, that optimize power consumption and save power. This extends operational capabilities and/or mobile duration.

Aspects of the disclosure operate in an unconventional manner at least by providing a system that includes a processor and a memory including computer program code, wherein the memory and the computer program code are configured to, with the processor, cause the processor to: change operation of a mobile platform to a first deployed mode of the mobile platform; navigate the mobile platform along a flight path toward at least one of a target or a source utilizing the first deployed mode, change operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjust a logarithmic flight path of the mobile platform based on a real-time input utilizing the second deployed mode; and execute the adjusted logarithmic flight path with the mobile platform utilizing the second deployed mode.

Aspects of the disclosure operate in an unconventional manner at least by providing a system that includes: a processor; and a memory comprising computer program code, the memory and the computer program code configured to, with the processor, cause the processor to: navigate a mobile platform along a path toward at least one of a target or a source; and perform a maneuver with the mobile platform based on at least one of a sensor input, a real-time input, an environmental change, a distance to the at least one of the target or the source, movement of the at least one of the target or the source, or a change to the at least one of the source or target, wherein performing the maneuver comprises selecting a maneuver pattern based on at least one of a threat profile, an operational state of the mobile platform, an environmental condition, or a repository of maneuver patterns

Example technical solutions to the technical problems described herein include a states and modes navigation framework that enables a mobile platform to transition between distinct states and distinct modes during navigation. The states and modes framework disclosed herein enables aspects of the disclosure to provide the technical effect of increased adaptability to dynamic environments. Aspects of the disclosure provide the technical solution of a log approach that provides a dynamically adjustable logarithmic flight path, for example using a pseudo-Kalman filtering technique. The log approach provided by aspects of the disclosure provides the technical effect of enhancing accuracy, for example by continuously correcting trajectories based on real-time data.

Another exemplary technical solution provided by the disclosure includes the utilization of adaptive evasive maneuvers, for example informed by one or more onboard sensors including, but not limited to, microphones, optical sensors, thermal sensors, and/or the like. The evasive maneuvers disclosed herein provide the technical effect of enhanced protective capabilities, for example to provide safer operation amidst potential threats, contributing to more successful navigations.

Aspects of the disclosure provide the technical solution of intelligent breadcrumb navigation, which includes path creation based on real-time data to provide the technical effects of aiding navigation, guiding through complex environments, coordinating operations, maintaining supply lines, and/or potentially evading previously dangerous routes. The technical solutions of the battery management protocols disclosed herein (e.g., solar energy integration, expendable battery cartridges, power-saving modes during non-critical flight phases) provide the technical effects of enhanced power optimization and/or extended operational capabilities.

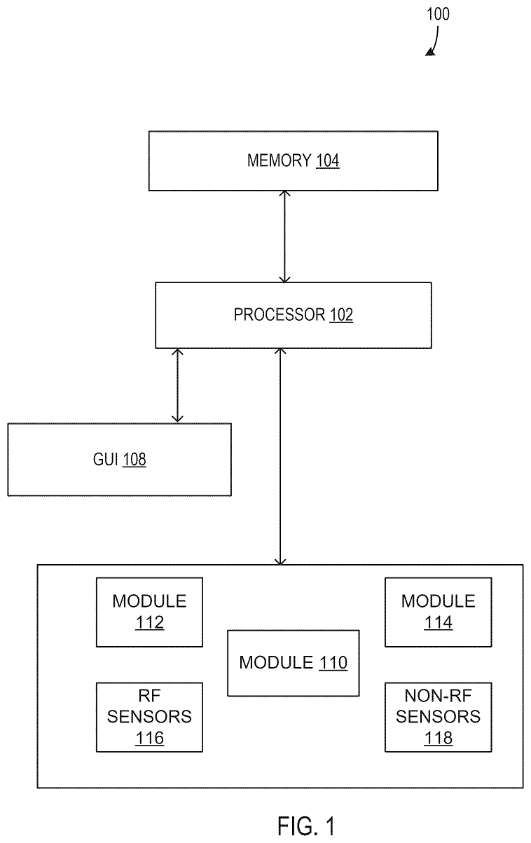

Referring to the figures, FIG. 1 is a block diagram illustrating a navigation system 100. In some examples, the system 100 includes a processor 102 and a memory 104 configured to store computer program code. The memory 104 and the computer program code are configured to, with the processor 102, cause the processor 102 to perform various operations, functions, and/or the like of the system 100. For example, the processor 102 may function as a central processing entity, managing operations and coordinating data flow between components. The memory 104 is connected to the processor 102 and stores instructions and data necessary for the execution of the various operations, functions, and/or the like of the system 100, such as functions and algorithms for navigation, maneuvering, and/or the like.

In some examples, one or more operations, functions, results, conclusions, calculations, determinations, generations, detections, and/or the like of the system 100 are provided for display via a graphical user interface (GUI). The GUI includes a GUI 108 of the system 100, and/or a GUI of another system, computing device, electronic device, server, and/or the like. The GUI 108 is interfaced with the processor 102, enabling user interaction and visualization of data processed by the system 100, for example allowing for configuration changes and/or monitoring of the various operations of the system 100.

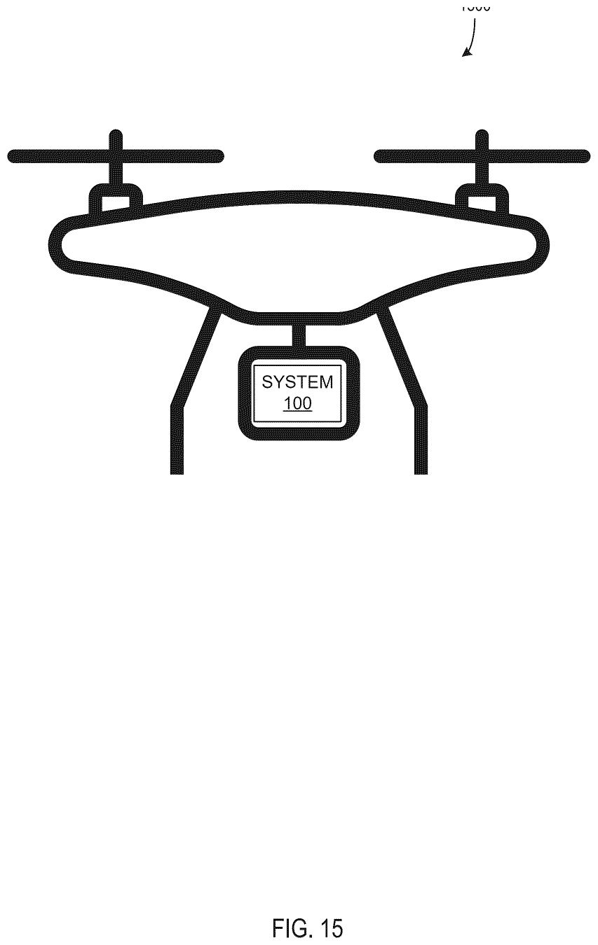

In some examples, the system 100 is configured for use onboard a platform, such as, but not limited to, a mobile platform (e.g., the mobile platform 1500 shown in FIG. 15, etc.), a stationary platform, and/or the like. In some examples, the systems and methods disclosed herein are used with (e.g., onboard, onboard control, remote from, remote control, etc.) one or more uncrewed, autonomous platforms.

Examples of mobile platforms include, but are not limited to, uncrewed vehicles, uncrewed aerial vehicles (UAVs), aircraft (e.g., rotorcraft, fixed wing aircraft, gliders, airplanes, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), marine vehicles (e.g., boats, ships, etc.), surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, the system 100 may be used onboard a mobile platform while the mobile platform is moving and/or while the mobile platform is stationary.

Examples of stationary platforms include, but are not limited to, stations, arrays, central controls, centralized control stations, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like.

As used herein, a “source” or “target” is any destination of the mobile platform using a navigation system as described herein. A “source” includes any type of emission source of any type of signal, such as, but not limited to, an RF emitter; an RF transmitter; an emitter and/or transmitter of any other type of frequency signal (e.g., a visible frequency, an infrared frequency, an optical frequency, an x-ray frequency, a microwave frequency, etc.); a magnetic field; and/or the like. As used herein, a “target” includes, but is not limited to, any source. However, the term “target” is not limited to being a source, but rather may additionally or alternatively include any other object of interest, for example a structure, mobile platform, building, vehicle, a destination, and/or the like that does not emit one or more signals or emits one or more signals below a threshold.

The system 100 includes one or more modules (e.g., the modules 110 and 112) that operatively connected to the memory 104, the processor 102, and/or each other for performing various functions, operations, and/or the like of the system 100. In the illustrated implementation, the system 100 includes a sensor module 110, a navigation and flight management module 112, and a maneuvering module 114. The architecture of the modules 110, 112, and 114 of the system 100 enables navigation within dynamic environments. Although described as a navigation and flight management module 112, it will be understood that the module 112 may be additionally or alternatively configured to manage any other type of motion, such as, but not limited to, the motion of a ground vehicle along the ground, the motion of a marine vehicle on or under the surface of a body of liquid, and/or the like.

The system 100 includes one or more RF sensors 116. For example, each RF sensor 116 is configured to acquire emission data of detected RF emissions of a target and/or a source. The RF sensor(s) 116 include any number and/or different types of RF sensors. Emission data of the detected RF emissions that is acquired by the RF sensors 116 may include, but is not limited to, frequency characteristics, signal strength, directional orientation, positional coordinates, locations, and/or the like of the detected RF emissions. In some examples, the emission data is acquired by the RF sensors 116 onboard a mobile platform.

Optionally, the system 100 includes one or more non-RF sensors 118 that are configured to acquire non-RF data. The non-RF sensor(s) 118 may include any number and/or different types of non-RF sensors, such as, but not limited to, cameras, acoustic sensors, microphones, optical sensors, thermal sensors, infrared sensors, microwave sensors, environmental monitors, LiDAR systems, x-ray detectors, electromagnetic field detectors, and/or the like. Non-RF data acquired by the non-RF sensors 118 may include, but is not limited to, audio information, audio cues, visual information, visual cues, environmental information, environmental variables, wind patterns, wind speeds, wind direction, terrain features, terrain information, video footage, thermal information, temperatures, and/or the like.

In some examples, the system 100 performs a method that includes: changing operation of a mobile platform to a first deployed mode of the mobile platform; navigating the mobile platform along a flight path toward at least one of a target or a source utilizing the first deployed mode; changing operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjusting a logarithmic flight path of the mobile platform based on a real-time input utilizing the second deployed mode; and executing the adjusted logarithmic flight path with the mobile platform utilizing the second deployed mode.

In some examples, the system 100 performs a method that includes: navigating a mobile platform along a flight path toward at least one of a target or a source; and performing a maneuver with the mobile platform based on at least one of a sensor input, a real-time input, an environmental change, a distance to the at least one of the target or the source, movement of the at least one of the target or the source, or a change to the at least one of the source or target, wherein performing the maneuver includes selecting a maneuver pattern based on at least one of a threat profile, an operational state of the mobile platform, an environmental condition, or a repository of maneuver patterns.

As described above, the system 100 is configured to provide a states and modes framework that systematically manages operation phases of the navigation system providing navigation to a mobile platform. In other words, the states and modes framework disclosed herein delineates operations through a structured configuration that governs the behavior (e.g., modes, etc.) of a mobile platform across distinct operational stages. For example, the states and modes framework defines various states of the mobile platform and defines various operational modes that are performed by the mobile platform across the defined states. A “state” includes the overall condition of the mobile platform, such as, but not limited to, on, off, pre-motion (e.g., pre-flight, etc.), deployed, moving, and/or the like. Optionally, a state of the mobile platform can only be changed from outside the system 100. A “mode” includes a behavior of the mobile platform, such as, but not limited to, an action, a task, a function, and/or the like. Optionally, a mode of the mobile platform can be changed within the system 100.

The states and modes framework of the system 100 delineates the various stages of the mobile platform and delineates the various modes that may be performed in each state. For example, a pre-flight mode includes one or more operational actions, tasks, functions, and/or the like performed by the mobile platform while the mobile platform is in a pre-flight state, and a deployed mode includes one or more operational actions, tasks, functions, and/or the like performed by the mobile platform while the mobile platform is in a deployed state.

In some examples, the system 100 is configured to change the state and/or the mode of the mobile platform (e.g., change from one state to another and/or change from one mode to another) based on a sensor input, a real-time input, an environmental change, an operational parameter change, a status of the mobile platform, a power level, and/or a distance to a target and/or a source. In other words, the system 100 is, in some examples, configured to dynamically change and/or reconfigure plans (e.g., states, modes, tasks, functions, etc.) with on-board decision making.

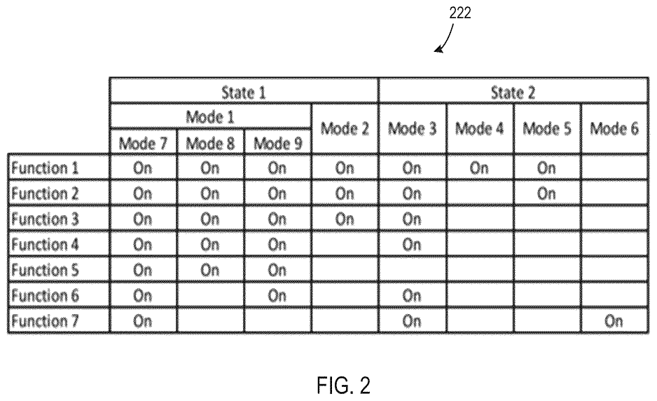

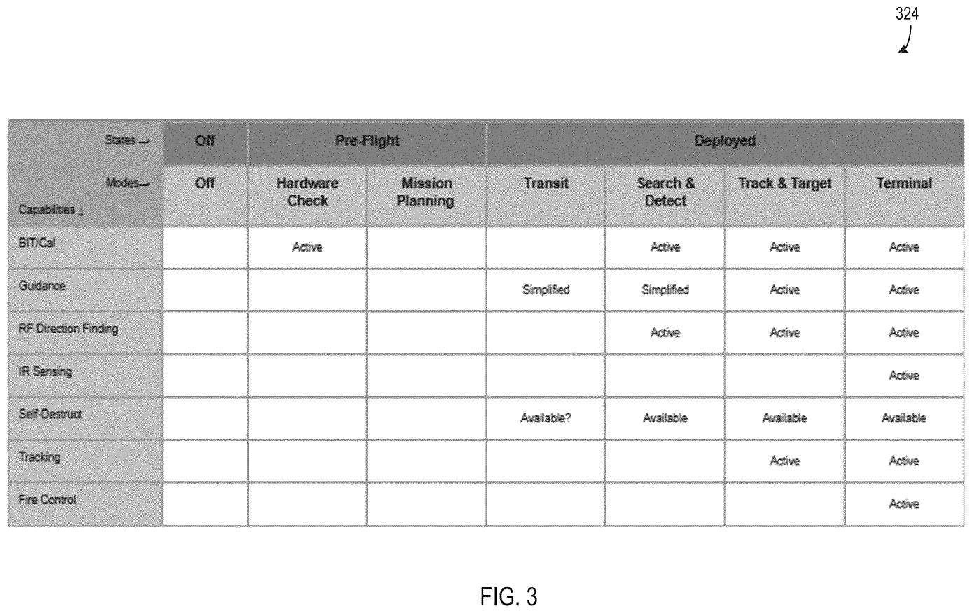

Optionally, the states and modes framework of the system 100 is represented at least for illustrative purposes by a table and/or matrix. For example, FIGS. 2 and 3 include respective tables 222 and 324 that illustrate examples of a states and modes framework of the system 100. As shown in FIG. 2, the table 222 has various Modes 1-9 defined across States 1 and 2. The table 222 also maps various functions 1-7 of the mobile platform to the state(s) and mode(s) within which each function is performed. FIG. 3 illustrates a functional matrix that maps the performance of various capabilities of the mobile platform across the states of Off, Pre-flight, and Deployed, and across the modes of Off, Hardware Check, Mission Planning, Transit, Search & Detect, Track & Target, and Terminal.

In some implementations of the system 100, the navigation and flight management module 112 is configured to transition the mobile platform from a pre-motion state (e.g., a pre-flight state, etc.) to a deployed state. The transition from the pre-motion state to the deployed state includes changing operation of the mobile platform from a pre-motion mode to a deployed mode of the mobile platform. The navigation and flight management module 112 is configured to thereafter change operation of the mobile platform from the deployed mode to another deployed mode of the mobile platform, for example based on a sensor input, a real-time input, an environmental change, an operational parameter change, a status of the mobile platform, a power level, a distance to a target and/or a source, and/or the like. In some examples, the system 100 (e.g., the navigation and flight management module 112, etc.) is configured to initiate the pre-motion state.

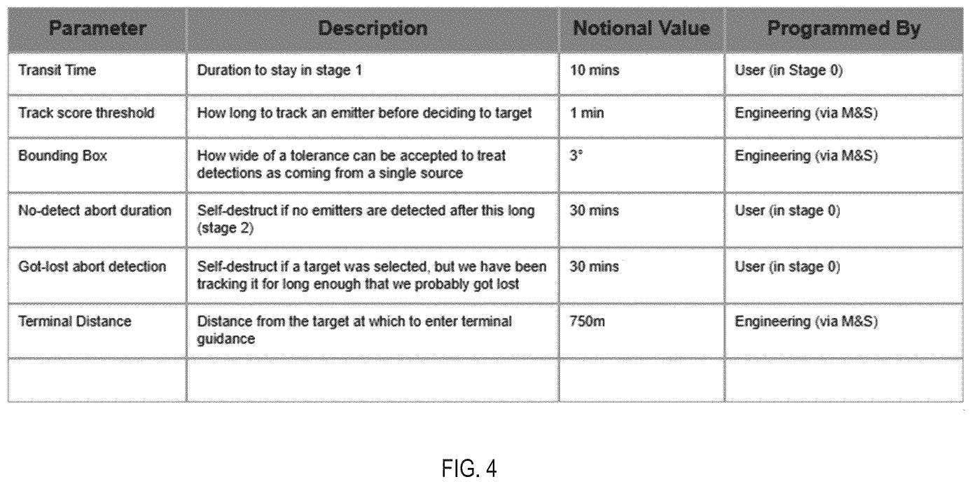

Referring again to FIG. 1, examples of the various states and/or modes of the system 100 and the mobile platform will now be described. In an example of an Off state, modes performed may include, but are not limited to, assembly of the mobile platform. In a Pre-motion state, an example of a mode performed includes system checks and/or preparation protocols prior to the mobile platform's launch, for example to ensure that all systems and sub-systems (e.g., including sensors, communication links, and/or other hardware) are operational and that the mobile platform is ready for operation execution. These system checks and/or preparation protocols may include, for example, calibration and/or built-in testing (BIT). Another example of a mode performed in the Pre-motion state includes setting operational parameters. FIG. 4 illustrates non-limiting examples of operational parameters.

In a Deployed state of the mobile platform, modes performed by the mobile platform include a Transit mode. For example, functions performed during the Transit mode may include, but are not limited to, following a predetermined and/or dynamically adjusted flight path, adjusting a flight path, optimizing a flight path for energy conservation, conserving energy, using solar power, using an expendable battery cartridge, using a fuel cartridge, using a combustible fuel (e.g., gasoline, alcohol, nitrous oxide, etc.), guidance, self-destruct, and/or the like. Optionally, one or more of the functions of the Transit mode is based on (e.g., triggered by) a real-time input. In the Transit mode, optimal energy use and/or navigation efficiency may be emphasized, for example enabling adjustments based on real-time data. Optionally, the Transit mode dictates that the mobile platform moves into an area by following an initial heading for a duration of time, without changing heading, and/or without using any using sensors.

In some examples, the Transit mode includes a self-destruct instruction that instructs the mobile platform to self-destruct, for example upon a battery charge decreasing below a threshold, based on a flight computer not sending messages, etc. Optionally, the system 100 is configured to exit the Transit mode upon elapse of a duration of time, and/or the like. The states and modes framework provided by the system 100 may eliminate or reduce a need to begin attempting to detect sources and/or targets from a distance (e.g., before reaching a sensing and/or other range of the source and/or target).

Another example of a mode performed by the mobile platform during the Deployed state includes a Search and Detect mode. In the Search and Detect mode, the mobile platform scans the environment and identifies a potential target and/or a potential source, for example using onboard sensing technologies (e.g., the sensors 116, the sensors 118). For example, the Search and Detect mode may leverage sensors to collect and/or process data, facilitating source and/or target detection and/or classification. Examples of functions performed during the Search and Detect mode include, but are not limited to, deploying a sensor array, sensing of a wide area using the RF sensors 116, selecting a source, selecting a target, conducting a BIT and/or calibration, conducting an automatic BIT and/or calibration, maintaining a same heading, conducting a wide-angle coarse RF search, and/or the like. Optionally, the system 100 is configured to exit the Search and Detect mode upon tracking of a source and/or target within a bounding box for a duration of time, and/or the like.

The Track and Target mode is another example of a mode performed by the mobile platform during the Deployed state. For example, once potential sources and/or targets are identified, the system 100 may transition to the Track and Target mode wherein the mobile platform surveilles one or more identified sources and/or targets (e.g., maintains surveillance on a selected source and/or target). The Track and Target mode may include navigating to a selected source and/or target, refining an estimate of a position and/or location of a selected source and/or target, and/or the like. Other examples of functions performed during the Track and Target mode include, but are not limited to, following detected sources and/or targets using (e.g., onboard) sensor data, analyzing sensor data, adjusting a trajectory of the mobile platform (e.g., to enable continuous monitoring and/or navigation), adjusting a flight path of the mobile platform, conducting a BIT and/or calibration, conducting an automatic BIT and/or calibration, conducting a fine-angle RF detection, forming tracks on a source and/or target, estimating a range to a source and/or target, and/or the like.

In some examples, the system 100 is configured to exit the Track and Target mode upon an estimated range to a source and/or target falling below a threshold, and/or the like. Optionally, the Track and Target mode includes a self-destruct instruction that instructs the mobile platform to self-destruct, for example upon failure of a BIT, upon losing track of a source and/or target (e.g., and consequently reverting to the Search and Detect mode), upon elapse of a threshold duration of time, upon a battery being below a threshold amount of remaining power, and/or the like.

In some examples, a Terminal mode is performed by the mobile platform in the Deployed state of the mobile platform. The Terminal mode addresses the final engagement with a selected source and/or target. In other words, the mobile platform is configured to engage a source and/or target in the Terminal mode. The Terminal mode may include terminal sensing and performing a final maneuver to achieve an intended outcome. The Terminal mode may include determining a terminal flight path, for example: a random path; a path based on sensor data, a quantity of mobile platforms in an area, and/or a quantity of obtained flight data; and/or the like.

In some examples, engaging the source and/or target in the Terminal mode includes navigating along an approach path, adjusting a (e.g., flight, ground, marine, etc.) path of the mobile platform, adjusting a logarithmic flight path of the mobile platform, and/or the like. Other examples of functions performed during the Terminal mode include, but are not limited to: engaging the source and/or target using a dynamically calculated trajectory; dynamically correcting a flight path based on real-time data (e.g., environmental data, source data, target data); optimizing navigation accuracy based on real-time data; activating a secondary sensor (e.g., an IR camera); arming, activating, and/or initiating ordinance; and/or the like. In some examples, the system 100 employs visual cameras (e.g., first person view (FPV) cameras), thermal sensors, and/or short-range radar (e.g., 60 Hz) for relatively close-range navigation.

Optionally, the Terminal mode includes a self-destruct instruction that instructs the mobile platform to self-destruct, for example upon impact of an ordinance.

In some examples, the system 100 enters into a contingency mode, which includes transitioning to the contingency mode from any other mode. For example, the system 100 may enter a contingency mode upon: failure of a BIT no source and/or target being tracked for a (e.g., consistent) duration of time; failure of finding a source and/or target; elapse of a threshold duration of time; remaining power levels being insufficient to complete the operation (e.g., reach the source and/or target, reach the Termination mode, complete the Termination mode); and/or the like. Contingency modes executed by the system 100 include, but are not limited to, a self-destruct mode wherein the mobile platform self-destructs, a return to base mode wherein the mobile platform returns to base, a fly to battery depletion mode wherein the mobile platform continues to fly until power is depleted, and/or the like.

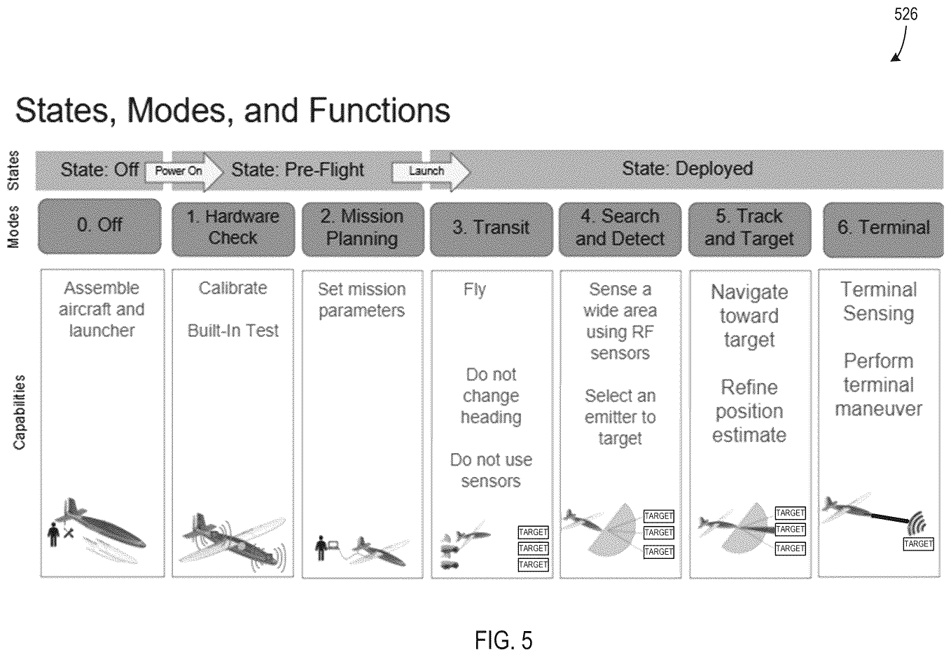

FIG. 5 is a flowchart 526 that illustrates an exemplary implementation of the states and modes framework of the system 100. For example, FIG. 5 illustrates an example of a seek and destroy operation. FIG. 5 is structured to illustrate the sequential progression through various phases, for example through various states and modes. The exemplary states and modes framework illustrated in FIG. 5 consists of three primary states: Off, Pre-Flight, and Deployed. Each state is subdivided into modes ranging from 0 to 6, each associated with specific capabilities of the mobile platform.

In the Off state, mode 0 enables the assembly of the mobile platform and launcher, providing the foundational setup for the operation. Transitioning into the Pre-Flight state, mode 1 involves hardware checks, including calibration and BIT to ensure functionality. Mode 2, Mission Planning, entails setting parameters for executing objectives.

The Deployed state, leading from the Pre-Flight state via a launch, includes modes 3 to 6. Mode 3, Transit, dictates the mobile platform to fly into a geographic location without changing heading or using sensors. Mode 4, Search and Detect, enables the sensing of a wide area using RF sensors, selecting a target, etc. Mode 5, Track and Target, involves navigating towards the target, refining position estimates, and/or the like. Mode 6, Terminal, includes terminal sensing and performing the final maneuver to achieve the intended outcome.

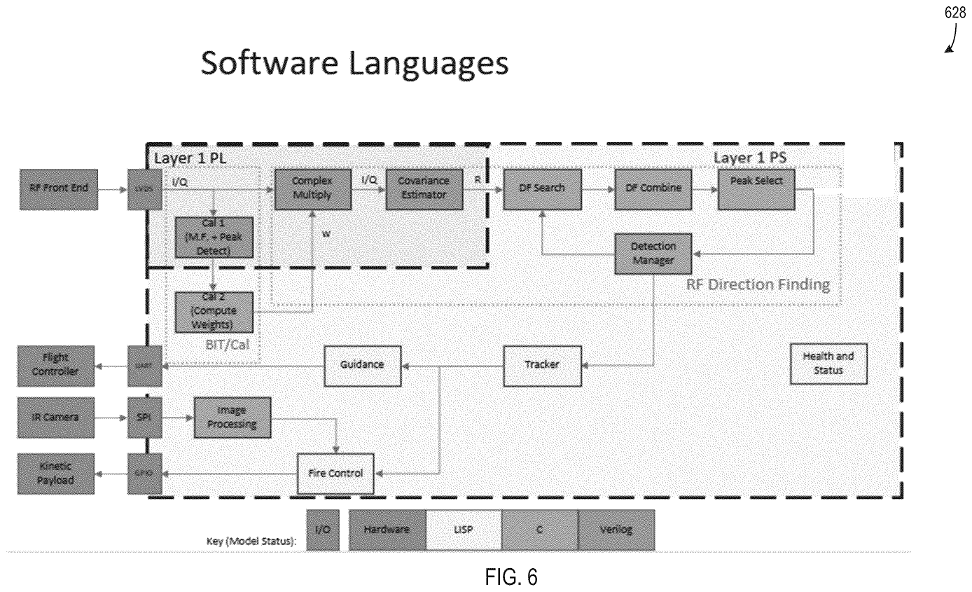

FIG. 6 illustrates an exemplary software implementation of the system 100. In other words, FIG. 6 is a block diagram 628 detailing a non-limiting example of the data flow and processing modules of the system 100. The architecture shown in FIG. 6 includes two layers and emphasizes different software aspects of the system, for example including hardware interfacing and computational tasks.

Referring again to FIG. 1, as described above, the system 100 is configured to provide a log approach that provides a dynamically adjustable logarithmic flight path. The log approach enhances accuracy, for example by periodically or continuously correcting trajectories based on real-time data. A mobile platform uses the log approach strategy, for example, to execute terminal engagement with increased precision. The log approach capability may see applications in reconnaissance and/or surveillance operations (e.g., where relatively precise target engagement is desired).

In some examples, the log approach capability of the system 100 includes adjusting a logarithmic flight path of the mobile platform, for example based on a real-time input. Moreover, the log approach strategy optionally employs an estimation theoretic technique (e.g., a pseudo-Kalman filtering algorithm etc.) for real-time adjustment of the logarithmic flight path, for example compensating for environmental variables and/or enhancing navigation targeting accuracy. Examples of the functionality of the log approach of the system 100 include, but are not limited to: determining a log approach trajectory; adjusting a logarithmic flight path; adjusting a logarithmic flight path using a pseudo-Kalman filtering technique and/or other estimation theoretic technique; generating an iterative predictive model; modulating a speed and/or an orientation of the mobile platform; maintaining and/or adjusting a strike angle and/or a navigation vector of the mobile platform; adjusting a logarithmic flight path based on a real-time input and/or an environmental condition, wind interference, and/or a movement of the source and/or target; and/or the like.

The log approach methodology disclosed herein may involve a sequence of operations designed to enhance the trajectory accuracy of a mobile platform, for example during terminal engagement. The log approach of the system 100 pertains to the optimal calculation and execution of a logarithmic flight path, which dynamically adjusts in real-time based on incoming data, for example to minimize navigation error.

In an example implementation, the system 100 initially processes environmental inputs and/or source and/or target data through onboard sensors and computational units to establish the initial parameters and/or variables influencing the flight path. The log approach trajectory is then calculated using a pseudo-Kalman filtering technique, which continuously assimilates data related to position, velocity, and/or other situational factors. The pseudo-Kalman technique enables real-time trajectory correction, for example by generating iterative predictive models that adapt to changing dynamics and/or environmental conditions, for example ensuring relatively precise navigation.

As the mobile platform approaches the source and/or target, the log approach path modulates the orientation and speed of the mobile platform to optimize the strike angle, continually adjusting for factors such as wind interference, source and/or target movement, and/or other variables. This adaptive mechanism maintains the mobile platform's optimal navigation vector while mitigating potential errors encountered during terminal descent.

In some examples, the system executes calculations throughout the log approach process to refine the logarithmic path as new data becomes available, ensuring that the final trajectory adheres to enhanced accuracy standards. This dynamic adjustment capability enables the achievement of the desired precision in target engagement, for example in varying and/or hostile operational environments.

In one example of a log approach scenario, the source and/or target has zero degree of elevation (horizon) from a relatively far distance, but appears to be below the mobile platform as the mobile platform approaches the destination. In this example, the logarithmic flight path is computed as the mobile platform approaches the source and/or target, for example by tracking the angle of elevation and adjusting the flight path accordingly. The log approach thus tilts the cone of uncertainty down, which improves navigation accuracy.

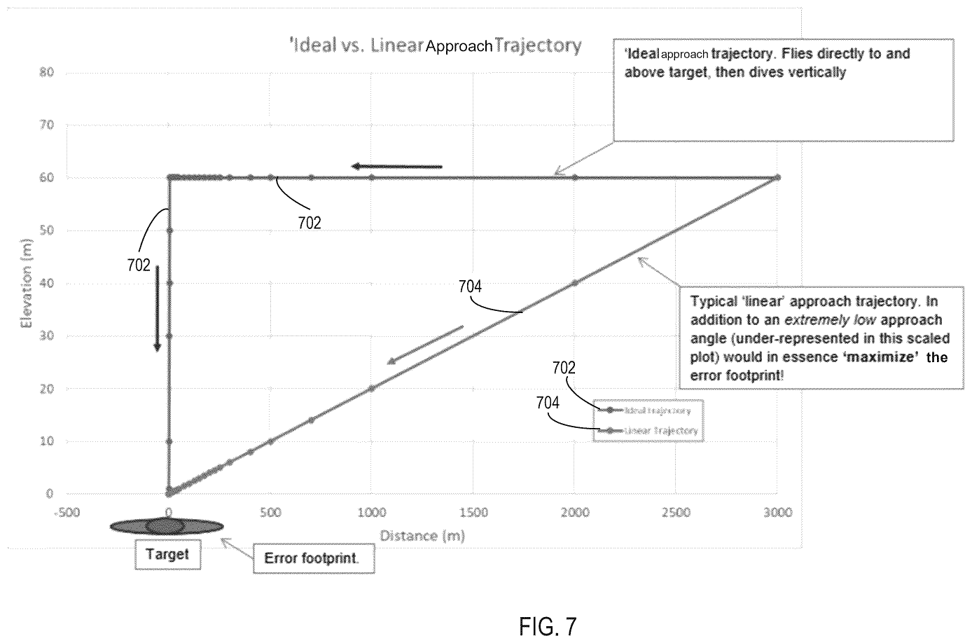

FIG. 7 illustrates an example comparison between two distinct approach trajectories, namely an ideal trajectory 702 and a linear trajectory 704. The vertical axis represents elevation in meters, while the horizontal axis measures distance in meters. The ideal trajectory 702 displays a direct vertical descent onto the source and/or target, minimizing the error footprint depicted as an oval around the target. The ideal trajectory 702 approach illustrates a steep descent directly over the source and/or target area, for example aimed at minimizing tracking and sensing errors.

Conversely, the linear trajectory 704 involves an angled, gradual approach towards the source and/or target. The linear trajectory 704 maximizes the error footprint by increasing the distance traveled before engaging the source and/or target. FIG. 7 illustrates how the linear approach creates a larger margin for sensing and tracking errors.

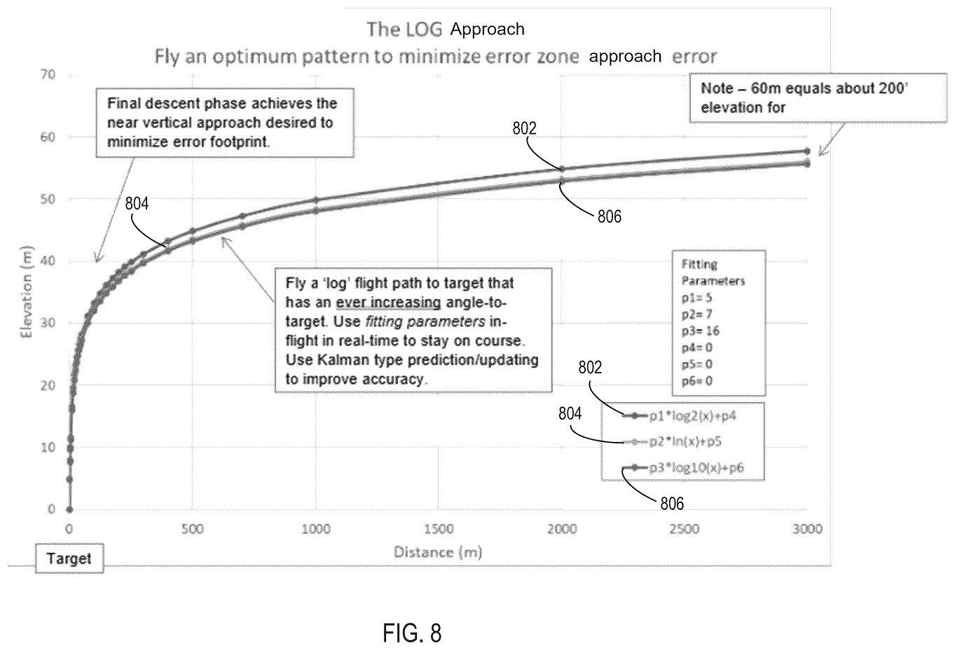

Turning to FIG. 8, the log approach uses an equation-based flight path for error minimization. The trajectory is depicted in FIG. 8 with smooth curves converging onto the source and/or target, emphasizing optimum pattern flight to reduce navigation errors. The flight path shown in FIG. 8 combines real-time fitting parameters 802, 804, and 806 that adapt the flight path dynamically, for example improving accuracy with the Kalman type prediction updating technique.

FIG. 8 further describes a final descent phase achieving a near-vertical approach, for example to minimize the error footprint using continuous adjustment during flight. FIG. 8 illustrates the result of maintaining a low elevation for the operation's expected outcomes.

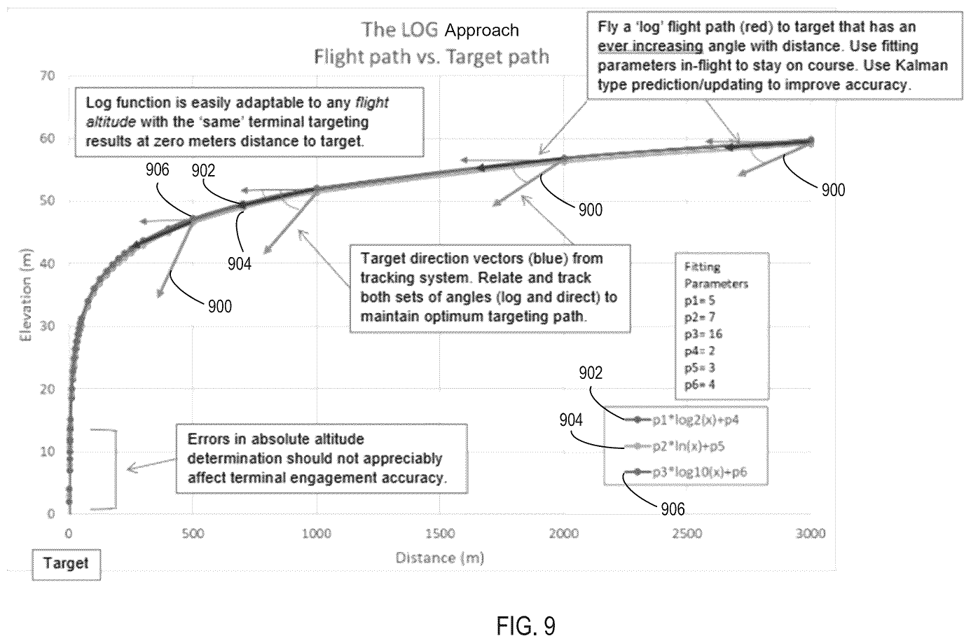

FIG. 9 elaborates on the log approach by comparing the log flight path against a source and/or target path. The log flight path is highlighted for its increasing angle-to-target characteristic as distance decreases. FIG. 9 illustrates vectors 900 indicating source and/or target direction from a tracking system, which coordinates with the log path for optimal target acquisition.

The flight path shown in FIG. 9 employs fitting parameters 902, 904, and 906 similar to those in FIG. 8, which illustrates the adaptability of the log function across different flight profiles. The errors in absolute altitude determination shown in FIG. 9 do not appear to impact terminal engagement accuracy in a meaningful or significant way, thus demonstrating the robustness of the system 100.

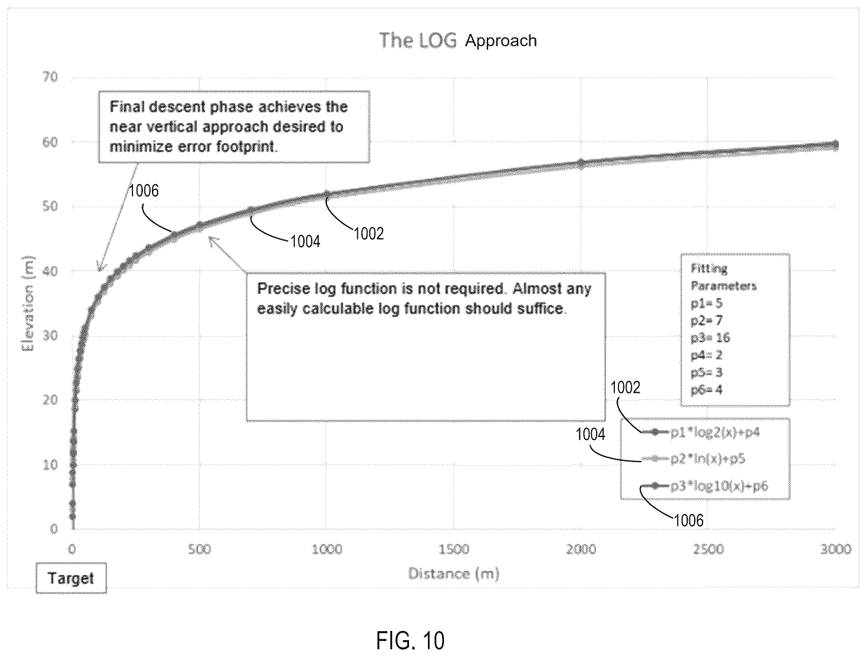

The log approach implementation shown in FIG. 10 improves computational efficiency. For example, FIG. 10 illustrates that almost any log function suffices for guiding the flight path, for example prioritizing quick calculations during approach stages less than 200 meters. This capability of the system 100 addresses the issue of high-power jammer saturation, maintaining higher altitude until the late approach to facilitate accurate navigation.

In the example of FIG. 10, fitting parameters 1002, 1004, and 1006 remain consistent with the other figures, for example maintaining similar variable values, which is indicative of the reliability and adaptability of the system 100. Additionally, FIG. 10 highlights the final descent phase that may minimize the error footprint near the source and/or target.

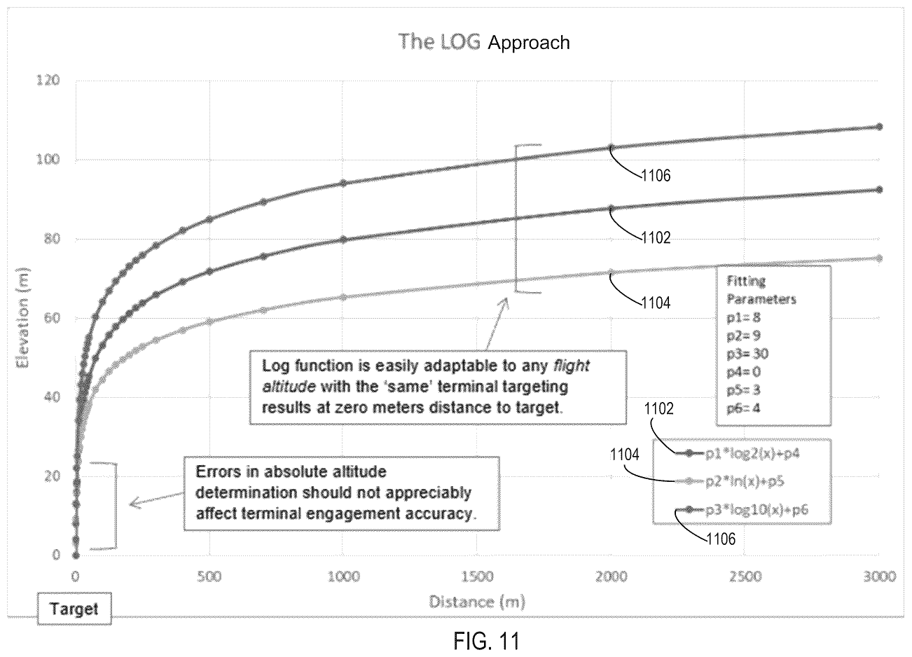

FIG. 11 illustrates the adaptability of the log approach function in varying flight altitudes, depicted with different curves corresponding to different mathematical functions. Despite diverse altitudes, the system 100 is configured to deliver relatively consistent terminal navigation accuracy. For example, FIG. 11 illustrates how flight adjustments may maintain precision. The errors in altitude determination noted on FIG. 11 do not significantly affect terminal engagement accuracy, reinforcing the efficacy of the adaptable log approach function across different operational scenarios. The fitting parameters 1102, 1104, and 1106 diverge slightly in value from the other figures, while maintaining overall adaptability.

Referring again to FIG. 1, as described above, the maneuvering module 114 of the system 100 is configured to perform (e.g., evasive, non-evasive, etc.) maneuvers with the mobile platform. In some examples, evasive maneuvers of the system 100 may include a series of maneuvers, procedures, operations, and/or the like designed to enhance the survivability and/or operational integrity of a mobile platform, for example in response to an identified threat. In some examples, the evasive and non-evasive maneuvers disclosed herein involve the integration of one or more onboard sensors and/or adaptive algorithms, for example to enable dynamic threat response.

In some examples, the maneuvering module 114 performs a maneuver with the mobile platform based on: a sensor input (e.g., an onboard sensor, a microphone, an optical sensor, a thermal sensor), a real-time input, an environmental change, a distance to a target and/or a source, movement of a target and/or source, a change to a target and/or source, and/or the like. For example, the maneuvering module 114 may perform evasive and/or non-evasive maneuvers based on one or more onboard sensor inputs, which may include, but are not limited to, acoustic sensors, microphones, thermal sensors, cameras, and/or optical sensors. In some examples, the sensors monitor the surrounding environment to detect potential threats such as, but not limited to, gunfire, explosions, destruction, other adverse conditions, and/or the like. In some examples, detected threats prompt the maneuvering module 114 to execute evasive actions, for example to preserve the operational integrity of the mobile platform. In some examples, evasive maneuvers can adjust dynamically in real-time, for example providing increased resilience against changing landscapes and/or environments. For example, in some implementations, performing the evasive maneuver includes executing flight adjustments in real-time.

Upon threat detection, the maneuvering module 114 may analyze sensor input to assess an origin, type, risk factor, and/or the like of the source and/or target. In some examples, the sensor input and/or other information is used to generate a threat profile of the source and/or target, which for example may form a basis for selecting an appropriate evasive maneuver strategy.

In some examples, selection of the maneuver to perform in a given situation includes accessing a repository of (e.g., pre-programmed) maneuver patterns (e.g., evasive maneuver patterns, non-evasive maneuver patterns, etc.). For example, one or more evasive patterns may be optimized for one or more specific threat scenarios. Moreover, and for example, the evasive patterns may be configured to disrupt, evade, mitigate, and/or avoid a threat trajectory. The maneuver patterns of the repository may be stored onboard and/or offboard the mobile platform. Accessing of the maneuver patterns by the maneuvering module 114 may include accessing patterns stored onboard the mobile platform and/or accessing patterns stored offboard the mobile platform. The maneuvering module 114 may select a maneuver based on a threat profile of a source and/or target, an operational state of the mobile platform, a current operational state of the mobile platform, an environmental condition, and/or the like.

Once a maneuver is selected, the maneuvering module 114 performs the maneuver by executing the corresponding flight adjustments. For example, performing the (e.g., evasive, non-invasive, etc.) maneuver includes changing a speed, altitude, and/or flight path of the mobile platform. In some examples, performing the maneuver includes accounting for terrain, a wind speed, an environmental condition, another situational variable, and/or the like.

Optionally, performing the maneuver includes executing flight adjustments in real-time. For example, throughout the maneuver, continuous feedback from the onboard sensors enables the maneuvering module 114 to refine the executed maneuver, for example to attempt to adapt to any changes in a threat's position, location, behavior, and/or the like. Such a feedback loop facilitates real-time adjustments, for example enhancing the ability of the mobile platform to effectively avoid, evade, disrupt, and/or mitigate an identified threat.

Another implementation of the system 100 includes intelligent breadcrumb navigation, for example to facilitate operation completion in unpredictable environments. As performed by the system 100, intelligent breadcrumb navigation includes creating (e.g., flight, ground, marine, etc.) paths based on live sensed data (e.g., real-time data acquired from the sensor 116 and/or 118). For example, intelligent breadcrumb navigation, in some examples, includes recording a departing leg of the path as a “breadcrumb path” such that the mobile platform has the option of returning along the same path. The intelligent breadcrumb navigation enables the system 100 to guide trailing mobile platforms, aid navigation, guide through complex environments, coordinate operations, maintain supply lines, evade previously dangerous routes, navigate around identified hazards, and/or the like.

Battery management protocols are performed by the system 100 in some examples. For example, the system 100 integrates energy augmentation using solar energy, expendable battery cartridges, fuel cartridges, combustible fuels (e.g., gasoline, alcohol, nitrous oxide, etc.), and/or the like. In the example of expendable battery cartridges, the cartridges may be carried by the mobile platform during flight to augment the energy provided by a battery of the mobile platform. Once an expendable battery cartridge has been depleted, the cartridge can be dropped, ejected, and/or the like from the mobile platform. The mobile platform is, in some examples, provided with solar cells, other solar energy generators, fuel cartridges, fuel tanks (e.g., combustible fuel tanks, etc.), and/or the like to augment the energy provided by a battery of the mobile platform.

In some examples, the battery management protocols implemented by the system 100 include adaptive power management solutions that optimize power consumption and/or save power. For example, the system 100 implements one or more energy-saving and/or energy-efficient modes during one or more (e.g., flight, navigation, etc.) phases, such as, but not limited to, during lower-demand phases, non-critical phases, and/or the like. In one example, the system 100 uses intermittent gliding to reduce power consumption (e.g., power is not engaged 100% during a loiter, cruise, and/or casual flight phase). In another example, the system 100 reduces the sensing duty time of the mobile platform to reduce power consumption (e.g., during a loiter, cruise, and/or casual phase). Optionally, the system 100 monitors ambient and/or component (e.g., memories, processors, modules) temperatures to facilitate battery management.

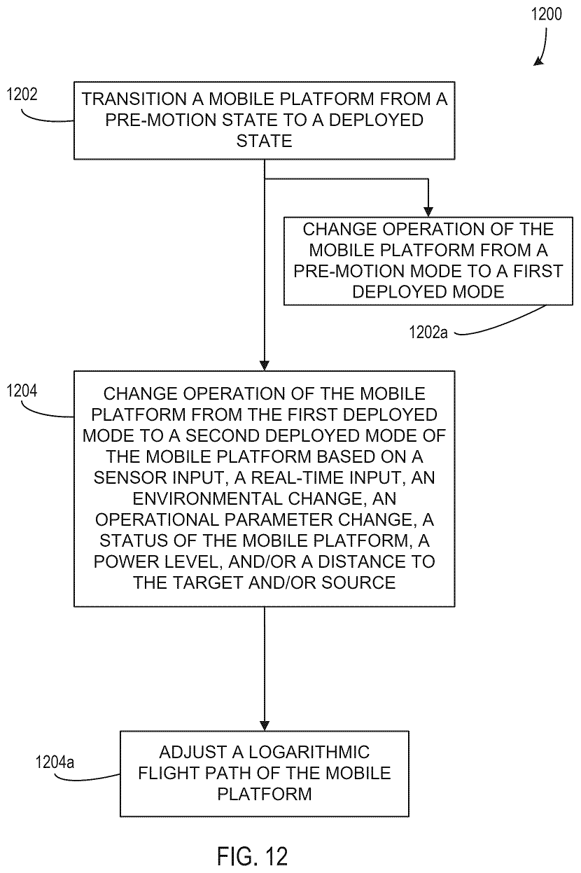

FIG. 12 is a flowchart illustrating an example of a method 1200 of operations, functions, and/or the like of the system 100 (FIG. 1). At 1202, the method 1200 includes transitioning a mobile platform from a pre-motion state to a deployed state. The transition from the pre-motion state to the deployed state includes changing, at 1202a, operation of the mobile platform from a pre-motion mode to a first deployed mode of the mobile platform. At 1204, the method 1200 includes changing operation of the mobile platform from the first deployed mode to a second deployed mode of the mobile platform based on at least one of a sensor input, a real-time input, an environmental change, an operational parameter change, a status of the mobile platform, a power level, or a distance to at least one of a target or a source. In some examples, the second deployed mode of the mobile platform includes adjusting, at 1204a, a logarithmic flight path of the mobile platform.

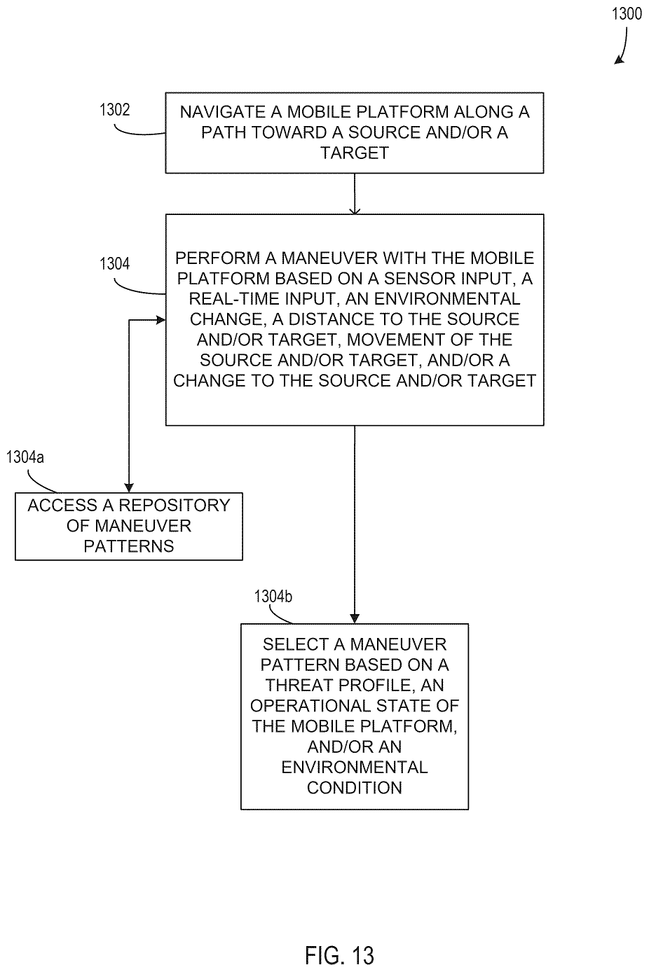

FIG. 13 is a flowchart illustrating an example of a method 300 of operations, functions, and/or the like of the system 100 (FIG. 1). At 1302, the method 300 includes navigating a mobile platform along a path toward at least one of a source or a target. At 1304, the method 300 includes performing a maneuver with the mobile platform based on at least one of a sensor input, a real-time input, an environmental change, a distance to the at least one of the source or target, movement of the at least one of the source or target, or a change to the at least one of the source or target.

In some examples, performing at 1304 the maneuver with the mobile platform includes accessing, at 1304a, a repository of maneuver patterns. Optionally, performing at 1304 the maneuver with the mobile platform includes selecting, at 1304b, a maneuver pattern based on at least one of a threat profile, an operational state of the mobile platform, or an environmental condition.

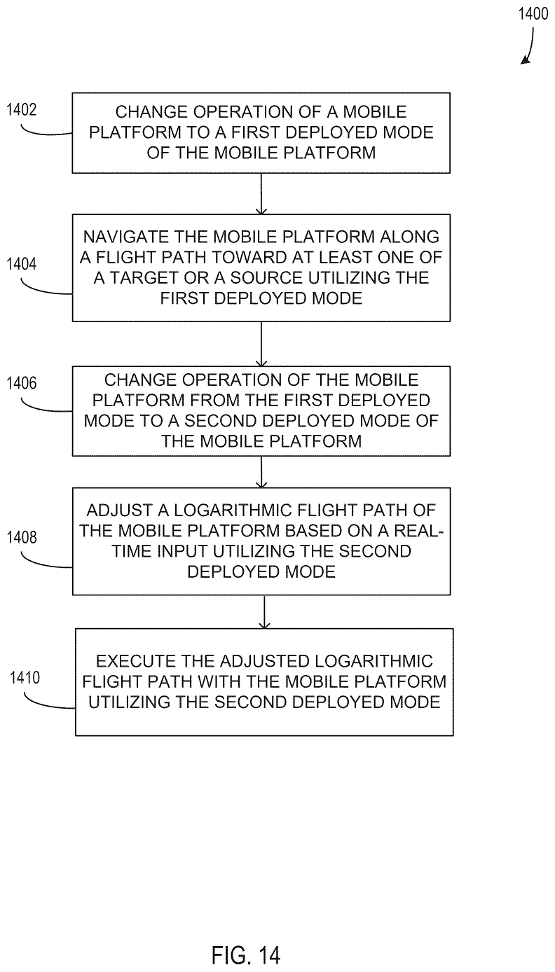

FIG. 14 is a flowchart illustrating an example of a method 1400 of operations, functions, and/or the like of the system 100 (FIG. 1). At 1402, the method 1400 includes changing operation of a mobile platform to a first deployed mode of the mobile platform. At 1404, the method 1400 includes navigating the mobile platform along a flight path toward at least one of a target or a source utilizing the first deployed mode. The method 1400 includes changing, at 1406, operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source. At 1408, the method 1400 includes adjusting a logarithmic flight path of the mobile platform based on a real-time input utilizing the second deployed mode. At 1410, the method 1400 includes executing the adjusted logarithmic flight path with the mobile platform utilizing the second deployed mode.

FIG. 15 illustrates an exemplary implementation of the system 100 being deployed onboard a mobile platform 1500. The system 100 is configured to perform the operations disclosed herein (e.g., navigation within dynamic environments, etc.) from onboard the mobile platform 1500. For example, the system 100 includes a states and modes framework that enables dynamic adaptability by governing transitions across distinct operational phases such as, but not limited to, pre-motion, transit, search, search and detect, track, track and target, engagement, terminal, and/or the like.

Although shown as a UAV rotorcraft, the mobile platform 1500 is not limited thereto but rather may include any other type of mobile platform.

### Exemplary Operating Environment

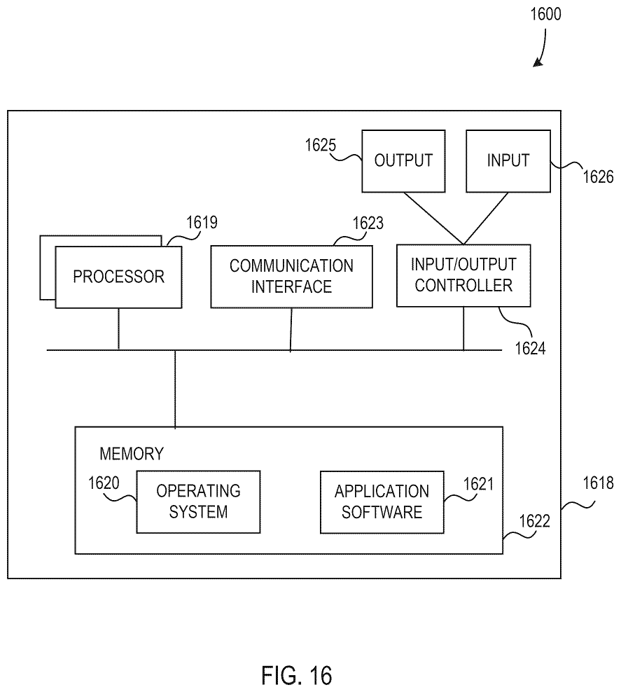

The present disclosure is operable with a computing apparatus according to an implementation as a functional block diagram 1600 in FIG. 16. In an example, components of a computing apparatus 1618 are implemented as a part of an electronic device according to one or more implementations described in this specification. The computing apparatus 1618 comprises one or more processors 1619 which may be microprocessors, controllers, or any other suitable type of processors for processing computer executable instructions to control the operation of the electronic device. Alternatively, or in addition, the processor 1619 is any technology capable of executing logic or instructions, such as a hard-coded machine. In some examples, platform software comprising an operating system 1620 and/or any other suitable platform software is provided on the apparatus 1618 to enable application software 1621 to be executed on the device.

In some examples, computer executable instructions are provided using any computer-readable media that is accessible by the computing apparatus 1618. Computer-readable media include, for example, computer storage media and communications media. Computer storage media, such as a memory 1622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1622) is shown within the computing apparatus 1618, it will be appreciated by a person skilled in the art, that, in some examples, the storage is distributed or located remotely and accessed via a network or other communication link (e.g., using a communication interface 1623).

Further, in some examples, the computing apparatus 1618 comprises an input/output controller 1624 configured to output information to one or more output devices 1625, for example a display (e.g., displaying a GUI) or a speaker, which are separate from or integral to the electronic device. Additionally, or alternatively, the input/output controller 1624 is configured to receive and process an input from one or more input devices 1626, for example, a keyboard, a microphone, or a touchpad. In one example, the output device 1625 also acts as the input device. An example of such a device is a touch sensitive display. The input/output controller 1624 may also output data to devices other than the output device, e.g., a locally connected printing device. In some examples, a user provides input to the input device(s) 1626 and/or receives output from the output device(s) 1625.

The functionality described herein can be performed, at least in part, by one or more hardware logic components. According to an implementation, the computing apparatus 1618 is configured by the program code when executed by the processor 1619 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Aspects of the disclosure include a method that includes: transitioning a mobile platform from a pre-flight state to a deployed state, wherein the transition from the pre-flight state to the deployed state comprises changing operation of the mobile platform from a pre-flight mode to a first deployed mode of the mobile platform; and changing operation of the mobile platform from the first deployed mode to a second deployed mode of the mobile platform based on at least one of a sensor input, a real-time input, an environmental change, an operational parameter change, a status of the mobile platform, a power level, or a distance to at least one of a target or a source.

In some examples, the second deployed mode of the mobile platform includes adjusting a logarithmic flight path of the mobile platform.

In some examples, the second deployed mode of the mobile platform includes adjusting a logarithmic flight path of the mobile platform using a pseudo-Kalman filtering technique.

In some examples, the second deployed mode of the mobile platform includes adjusting a logarithmic flight path of the mobile platform based on at least one of a real-time input or an environmental condition.

In some examples, the second deployed mode of the mobile platform includes performing an evasive maneuver with the mobile platform.

In some examples, the second deployed mode of the mobile platform includes performing an evasive maneuver with the mobile platform based on at least one of a sensor input, a real-time input, an environmental change, a distance to at least one of a target or a source, movement of the at least one of the target or source, or a change to the at least one of the target or source.

In some examples, the method further includes initiating the pre-flight state.

In some examples, the second deployed mode of the mobile platform includes a transit mode wherein the mobile platform is configured to at least one of adjust a flight path, conserve energy, use solar power, use a fuel cartridge, use a combustible fuel, use gasoline, or use an expendable battery cartridge.

In some examples, the second deployed mode of the mobile platform includes a transit mode wherein the mobile platform is configured to at least one of adjust a flight path, conserve energy, use solar power, use a fuel cartridge, use a combustible fuel, use gasoline, or use an expendable battery cartridge based on a real-time input.

In some examples, the second deployed mode of the mobile platform includes a search and detect mode wherein the mobile platform scans an environment and identifies at least one of a potential target or potential source.

In some examples, the second deployed mode of the mobile platform includes a search and detect mode wherein the mobile platform scans an environment and identifies at least one of a potential target or potential source using an onboard sensor.\

In some examples, the second deployed mode of the mobile platform includes a track and target mode wherein the mobile platform surveilles at least one of a target or source.

In some examples, the second deployed mode of the mobile platform includes a track and target mode wherein the mobile platform surveilles at least one of a target or source, wherein surveilling the at least one of the target or source includes adjusting a flight path of the mobile platform.

In some examples, the second deployed mode of the mobile platform includes a terminal mode wherein the mobile platform engages at least one of a source or target.

In some examples, the second deployed mode of the mobile platform includes a terminal mode wherein the mobile platform engages at least one of a source or target, wherein engaging the at least one of the source or target includes adjusting a flight path of the mobile platform.

In some examples, the second deployed mode of the mobile platform includes a terminal mode wherein the mobile platform engages at least one of a source or target, wherein engaging the at least one of the source or target includes adjusting a logarithmic flight path of the mobile platform.

Aspects of the disclosure include a system that includes a processor; and a memory including computer program code, wherein the memory and the computer program code are configured to, with the processor, cause the processor to: transition a mobile platform from a pre-flight state to a deployed state, wherein the transition from the pre-flight state to the deployed state comprises changing operation of the mobile platform from a pre-flight mode to a first deployed mode of the mobile platform; and change operation of the mobile platform from the first deployed mode to a second deployed mode of the mobile platform based on at least one of a sensor input, a real-time input, an environmental change, an operational parameter change, a status of the mobile platform, a power level, or a distance to at least one of a target or a source.

Aspects of the disclosure include a method that includes: navigating a mobile platform along a flight path toward at least one of a source or a target; and adjusting a logarithmic flight path of the mobile platform based on a real-time input.

In some examples, adjusting the logarithmic flight path of the mobile platform includes determining a log approach trajectory.

In some examples, adjusting the logarithmic flight path of the mobile platform includes adjusting the logarithmic flight path using a pseudo-Kalman filtering technique.

In some examples, adjusting the logarithmic flight path of the mobile platform includes generating an iterative predictive model.

In some examples, adjusting the logarithmic flight path of the mobile platform includes modulating at least one of a speed or an orientation of the mobile platform.

In some examples, adjusting the logarithmic flight path of the mobile platform includes at least one of maintaining or adjusting at least one of a strike angle or a navigation vector of the mobile platform.

In some examples, adjusting the logarithmic flight path of the mobile platform includes adjusting the logarithmic flight path based on at least one of an environmental condition, wind interference, or a movement of the at least one of the source or target.

Aspects of the disclosure include a system that includes a processor; and a memory including computer program code, wherein the memory and the computer program code are configured to, with the processor, cause the processor to: navigating a mobile platform along a flight path toward at least one of a source or a target; and adjusting a logarithmic flight path of the mobile platform based on a real-time input.

Aspects of the disclosure include a method that includes: navigating a mobile platform along a flight path toward at least one of a source or a target; and performing an evasive maneuver with the mobile platform based on at least one of a sensor input, a real-time input, an environmental change, a distance to the at least one of the source or target, movement of the at least one of the source or target, or a change to the at least one of the source or target.

In some examples, performing the evasive maneuver with the mobile platform includes performing the evasive maneuver based on input from an onboard sensor comprising at least one of a microphone, an optical sensor, or a thermal sensor.

In some examples, performing the evasive maneuver with the mobile platform includes performing the evasive maneuver based on input from an optical sensor and at least one of a microphone or a thermal sensor.

In some examples, the method further includes accessing at least one of an origin, a type, or a risk factor of the at least one of the source or target.

In some examples, the method further includes generating a threat profile of at least one of the source or target.

In some examples, performing the evasive maneuver with the mobile platform includes accessing a repository of evasive patterns.

In some examples, performing the evasive maneuver with the mobile platform includes selecting an evasive pattern based on at least one of a threat profile, an operational state of the mobile platform, or an environmental condition.

In some examples, performing the evasive maneuver includes executing flight adjustments in real-time.

In some examples, performing the evasive maneuver includes changing at least one of a speed, altitude, or flight path of the mobile platform.

In some examples, performing the evasive maneuver includes accounting for at least one of terrain, a wind speed, an environmental condition, or a situational variable.

Aspects of the disclosure include a method for operating an uncrewed aerial vehicle (UAV) capable of executing various mission phases through a structured states and modes framework, the method including: initiating a Pre-Flight state, wherein the UAV performs system checks and ensures operational readiness of onboard sensors and communication systems prior to launch; transitioning to a Transit mode, wherein the UAV follows an established or dynamically adjusted flight path to a designated mission area, with emphasis on energy efficiency and navigation optimization; entering a Search and Detect mode, wherein the UAV deploys advanced sensing technologies to scan the environment and identify potential targets, collecting and processing data to facilitate target detection and classification; transitioning to a Track and Target mode, wherein the UAV maintains surveillance on selected targets, involving analysis of sensor data and flight path adjustments to ensure continuous monitoring and navigation accuracy; and engaging in a Terminal phase, wherein the UAV executes target engagement strategies, incorporating dynamic flight path corrections to optimize navigation accuracy based on real-time environmental and target data.

Aspects of the disclosure include an adaptive trajectory control system for use in a mobile platform, the system including: a processing unit configured to receive real-time environmental and target data from a plurality of onboard sensors; a trajectory calculation module operatively connected to the processing unit, the module configured to compute a logarithmic flight path based on the received data, wherein the logarithmic flight path is calculated using a pseudo-Kalman filtering technique to facilitate dynamic adjustment of the mobile platform's trajectory; an iterative correction mechanism operatively coupled to the trajectory calculation module, the mechanism configured to execute continuous adjustments to the trajectory of the mobile platform based on updates from the trajectory calculation module, thereby optimizing approach parameters such as orientation and speed to minimize navigation error during terminal engagement; and wherein the system is operative to adapt the mobile platform's flight path in response to detected changes in environmental conditions and target movement, thereby maintaining an optimized navigation vector throughout the descent phase of terminal engagement.

Aspects of the disclosure include a system that includes a processor and a memory including computer program code, wherein the memory and the computer program code are configured to, with the processor, cause the processor to: change operation of a mobile platform to a first deployed mode of the mobile platform; navigate the mobile platform along a flight path toward at least one of a target or a source utilizing the first deployed mode, change operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjust a logarithmic flight path of the mobile platform based on a real-time input utilizing the second deployed mode; and execute the adjusted logarithmic flight path with the mobile platform utilizing the second deployed mode.

In some examples, adjusting the logarithmic flight path of the mobile platform includes generating the logarithmic flight path.

In some examples, adjusting the logarithmic flight path of the mobile platform includes computing the logarithmic flight path as the mobile platform approaches the at least one of the target or the source.

In some examples, adjusting the logarithmic flight path of the mobile platform includes at least one of determining a log approach trajectory, generating an iterative predictive model, modulating at least one of a speed or an orientation of the mobile platform, tracking an angle of elevation, or at least one of maintaining or adjusting at least one of a strike angle or a navigation vector of the mobile platform.

In some examples, adjusting the logarithmic flight path of the mobile platform based on the real-time input includes adjusting the logarithmic flight path based on at least one of an environmental condition, wind interference, or a movement of the at least one of the target or the source.

In some examples, adjusting the logarithmic flight path of the mobile platform includes adjusting the logarithmic flight path utilizing at least one of a pseudo-Kalman filtering technique or an estimation theoretic technique.

In some examples, the second deployed mode of the mobile platform includes a transit mode wherein the processor is configured to at least one of adjust a navigation flight path, conserve energy, use solar power, use a fuel cartridge, use a combustible fuel, use gasoline, or use an expendable battery cartridge.

In some examples, the second deployed mode of the mobile platform includes a search and detect mode wherein the processor is configured to scan an environment and identifies at least one of a potential target or a potential source.

In some examples, the second deployed mode of the mobile platform includes a track and target mode wherein a processor is configured to surveil the at least one of the target or the source.

In some examples, the second deployed mode of the mobile platform includes a terminal mode wherein a processor is configured to engage the at least one of the target or the source.

Aspects of the disclosure include a computerized method that includes: changing operation of a mobile platform to a first deployed mode of the mobile platform; navigating the mobile platform along a flight path toward at least one of a target or a source utilizing the first deployed mode; changing operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source; adjusting a logarithmic flight path of the mobile platform based on a real-time input utilizing the second deployed mode; and executing the adjusted logarithmic flight path with the mobile platform utilizing the second deployed mode.

In some examples, adjusting the logarithmic flight path of the mobile platform includes generating the logarithmic flight path.

In some examples, adjusting the logarithmic flight path of the mobile platform includes computing the logarithmic flight path as the mobile platform approaches the at least one of the target or the source.

In some examples, adjusting the logarithmic flight path of the mobile platform includes at least one of determining a log approach trajectory, generating an iterative predictive model, modulating at least one of a speed or an orientation of the mobile platform, tracking an angle of elevation, or at least one of maintaining or adjusting at least one of a strike angle or a navigation vector of the mobile platform.

In some examples, adjusting the logarithmic flight path of the mobile platform based on the real-time input includes adjusting the logarithmic flight path based on at least one of an environmental condition, wind interference, or a movement of the at least one of the target or the source.

In some examples, adjusting the logarithmic flight path of the mobile platform includes adjusting the logarithmic flight path utilizing at least one of a pseudo-Kalman filtering technique or an estimation theoretic technique.

In some examples, the second deployed mode of the mobile platform includes a transit mode wherein the processor is configured to at least one of adjust a navigation flight path, conserve energy, use solar power, use a fuel cartridge, use a combustible fuel, use gasoline, or use an expendable battery cartridge.

In some examples, the second deployed mode of the mobile platform includes a terminal mode wherein the processor is configured to engage the at least one of the target or the source.

Aspects of the disclosure include a system that includes: a processor; and a memory comprising computer program code, the memory and the computer program code configured to, with the processor, cause the processor to: navigate a mobile platform along a path toward at least one of a target or a source; and perform a maneuver with the mobile platform based on at least one of a sensor input, a real-time input, an environmental change, a distance to the at least one of the target or the source, movement of the at least one of the target or the source, or a change to the at least one of the source or target, wherein performing the maneuver comprises selecting a maneuver pattern based on at least one of a threat profile, an operational state of the mobile platform, an environmental condition, or a repository of maneuver patterns.

In some examples, performing the maneuver includes performing an evasive maneuver.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a processor; and
a memory comprising computer program code, the memory and the computer program code configured to, with the processor, cause the processor to:
change operation of a mobile platform to a first deployed mode of the mobile platform;
navigate the mobile platform along a flight path toward at least one of a target or a source utilizing the first deployed mode;
change operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source;
adjust a logarithmic flight path of the mobile platform based on a real-time input utilizing the second deployed mode; and
execute the adjusted logarithmic flight path with the mobile platform utilizing the second deployed mode.

2. The system of claim 1, wherein adjusting the logarithmic flight path of the mobile platform comprises generating the logarithmic flight path.

3. The system of claim 1, wherein adjusting the logarithmic flight path of the mobile platform comprises computing the logarithmic flight path as the mobile platform approaches the at least one of the target or the source.

4. The system of claim 1, wherein adjusting the logarithmic flight path of the mobile platform comprises at least one of determining a log approach trajectory, generating an iterative predictive model, modulating at least one of a speed or an orientation of the mobile platform, tracking an angle of elevation, or at least one of maintaining or adjusting at least one of a strike angle or a navigation vector of the mobile platform.

5. The system of claim 1, wherein adjusting the logarithmic flight path of the mobile platform based on the real-time input comprises adjusting the logarithmic flight path based on at least one of an environmental condition, wind interference, or a movement of the at least one of the target or the source.

6. The system of claim 1, wherein adjusting the logarithmic flight path of the mobile platform comprises adjusting the logarithmic flight path utilizing at least one of a pseudo-Kalman filtering technique or an estimation theoretic technique.

7. The system of claim 1, wherein the second deployed mode of the mobile platform comprises a transit mode wherein the processor is configured to at least one of adjust a navigation flight path, conserve energy, use solar power, use a fuel cartridge, use a combustible fuel, use gasoline, or use an expendable battery cartridge.

8. The system of claim 1, wherein the second deployed mode of the mobile platform comprises a search and detect mode wherein the processor is configured to scan an environment and identifies at least one of a potential target or a potential source.

9. The system of claim 1, wherein the second deployed mode of the mobile platform comprises a track and target mode wherein the processor is configured to surveil the at least one of the target or the source.

10. The system of claim 1, wherein the second deployed mode of the mobile platform comprises a terminal mode wherein the processor is configured to engage the at least one of the target or the source.

11. A computerized method comprising:
changing operation of a mobile platform to a first deployed mode of the mobile platform;
navigating the mobile platform along a flight path toward at least one of a target or a source utilizing the first deployed mode;
changing operation of the mobile platform from the first deployed mode to a second deployed mode of the mobile platform based on at least one of a sensor input, a real-time input, an environmental change, an operational parameter change, a status of the mobile platform, a power level, or a distance to at least one of the target or the source;
adjusting a logarithmic flight path of the mobile platform based on a real-time input utilizing the second deployed mode; and
executing the adjusted logarithmic flight path with the mobile platform utilizing the second deployed mode.

12. The computerized method of claim 11, wherein adjusting the logarithmic flight path of the mobile platform comprises generating the logarithmic flight path.

13. The computerized method of claim 11, wherein adjusting the logarithmic flight path of the mobile platform comprises computing the logarithmic flight path as the mobile platform approaches the at least one of the target or the source.

14. The computerized method of claim 11, wherein adjusting the logarithmic flight path of the mobile platform comprises at least one of determining a log approach trajectory, generating an iterative predictive model, modulating at least one of a speed or an orientation of the mobile platform, tracking an angle of elevation, or at least one of maintaining or adjusting at least one of a strike angle or a navigation vector of the mobile platform.

15. The computerized method of claim 11, wherein adjusting the logarithmic flight path of the mobile platform based on the real-time input comprises adjusting the logarithmic flight path based on at least one of an environmental condition, wind interference, or a movement of the at least one of the target or the source.

16. The computerized method of claim 11, wherein adjusting the logarithmic flight path of the mobile platform comprises adjusting the logarithmic flight path utilizing at least one of a pseudo-Kalman filtering technique or an estimation theoretic technique.

17. The computerized method of claim 11, wherein the second deployed mode of the mobile platform comprises a transit mode wherein a processor is configured to at least one of adjust a navigation flight path, conserve energy, use solar power, use a fuel cartridge, use a combustible fuel, use gasoline, or use an expendable battery cartridge.

18. The computerized method of claim 11, wherein the second deployed mode of the mobile platform comprises a terminal mode wherein a processor is configured to engage the at least one of the target or the source.

19. A system comprising:
a processor; and
a memory comprising computer program code, the memory and the computer program code configured to, with the processor, cause the processor to:
navigate a mobile platform along a path toward at least one of a target or a source; and
perform a maneuver with the mobile platform based on at least one of a sensor input, a real-time input, an environmental change, a distance to the at least one of the target or the source, movement of the at least one of the target or the source, or a change to the at least one of the source or target, wherein performing the maneuver comprises selecting a maneuver pattern based on at least one of a threat profile, an operational state of the mobile platform, an environmental condition, or a repository of maneuver patterns.

20. The system of claim 19, wherein performing the maneuver comprises performing an evasive maneuver.
